(19) United States
(12) Patent Application Publication
(10) Pub. No.: US 2025/0269918 A1
(43) Pub. Date: Aug. 28, 2025

(54) HYDROPNEUMATIC ROTARY SUSPENSION

(71) Applicant: PIEDRAFITA SYSTEMS S.L., Madrid (ES)

(72) Inventors: Luis BARRADA BUCH, San Sebastián de los Reyes (ES); Christian ANKENBAUER, Munich (DE); Luis CORRAL HOCHLEITNER, Madrid (ES); Oliver PLA, Madrid (ES); Pablo MARTIN MUÑOZ, Madrid (ES); Pablo CERROLAZA MARTÍNEZ, Madrid (ES)

(21) Appl. No.: 18/858,068

(22) PCT Filed: Apr. 20, 2023
(86) PCT No.: PCT/EP2023/060280

§ 371 Date: Oct. 18, 2024

(30) Foreign Application Priority Data
Apr. 20, 2022 (EP) 22382366.7

(51) Int. Cl. B62D 55/112

(52) U.S. Cl. CPC B62D 55/1125

(57) ABSTRACT

A rotary shock absorber for a vehicle and a pneumatic spring, in particular for a rotary shock absorber, are disclosed. The rotary shock absorber for a vehicle comprises a first component and a second component, wherein the second component is rotatably arranged relative to the first component. The rotary shock absorber comprises a pneumatic spring that is adapted to provide an elastic force F against rotation of the second component relative to the first component. The second component forms a pneumatic cavity of the pneumatic spring. The second component forms a hydraulic cavity of the pneumatic spring. The hydraulic cavity comprises a toroidal section.

The present invention relates to a rotary shock absorber for a vehicle and to a pneumatic spring, in particular for a rotary shock absorber.

GB 1 165 692 A describes a vehicle suspension system, comprising a flexible container, functionally arranged in series with a reservoir filled with liquid, wherein the reservoir is configured as a toroidal cylinder. U.S. Pat. No. 4,712,780 describes a hydropneumatic spring suspension device with a pneumatic spring in the form of a cylindrical siphon and a hydraulic damper, arranged together in a housing. A cover of the damper moves on a circular path within the housing in reaction to a shock-like load. U.S. Pat. No. 4,537,422 describes a hydropneumatic suspension unit, comprising a rotary friction damper system and a gas spring system comprising a piston connected to a piston rod. U.S. Pat. No. 7,770,902 B1 describes an in-arm suspension with a fluid strut, wherein the fluid strut com-bines a spring function and a damper function. The fluid strut comprises a linear damper and a piston connected to a piston rod. EP 0 098 614 A2 describes a rotary piston with a damping cavity and a pneumatic cavity in one housing. EP 3 333 447 B1 describes a hydraulic rotary shock absorber, comprising hydraulic connections through which fluid is forced due to a pressure differ-ence. The object of the present invention is to provide an improved hydropneumatic suspension device.

The invention provides a rotary shock absorber for a vehicle, wherein the rotary shock absorber for a vehicle comprises a first component and a second component, wherein the second component is rotatably arranged relative to the first component, in particular around a first rotation axis. A hydraulic damper may be adapted to provide a damping force against a relative rotation of the second component regarding the first component, wherein the hydraulic damper comprises a first hydraulic cavity formed in between the first component and second component. A pneumatic spring is adapted to provide an elastic force against the relative rotation of the second component regarding the first component, wherein the second component forms a pneumatic cavity of the pneumatic spring. The pneumatic spring may be functionally arranged in parallel to the hydraulic damper. The second component may form a hydraulic cavity of the pneumatic spring. The hydraulic cavity may comprise a toroidal section. The hydraulic cavity may comprise a linear section connected to the toroidal section, in particular by a fluid connection. The hydraulic damper may be arranged in parallel to the pneumatic spring. The hydraulic damper may be arranged within a hydraulic damper device. The hydraulic damper device may be an assembly comprising the hydraulic damper. The hydraulic damper device may be an assembly within which the hydraulic damper is arranged or mounted. The hydraulic damper may comprise a throttle. Additionally or alternatively, the hydraulic damper may comprise a valving assembly. The valving assembly may comprise a piston and a spring for changing the cross section or flow conditions in a passage of the valving assembly. The valving assembly may comprise one or more check valves. The valving assembly may provide adapted damping depending from the fluid flow through the valving assembly. The valving assembly may be adapted to provide different damping characteristics depending on the flow direction.

In particular, a heat flow from the hydraulic damper, in particular from a hydraulic rotary damper, to the pneumatic spring may be reduced. By spatially separating the pneumatic spring from the hydraulic damper, a potential thermal expansion of a gaseous component of the pneumatic spring due to heat generation in the hydraulic damper, may be reduced. In particular, the thermal expansion of the gaseous component of the pneumatic spring may be reduced. Thus, the hydropneumatic suspension device, in particular a hydropneumatic rotary suspension device, may have increased mechanical stability. Thermal perturbations due to thermal input from the hydraulic damper to the pneumatic spring may be reduced.

The first component may comprise the hydraulic damper. The first component may further comprise a mounting base for attaching the first component to a vehicle body. Thus, the heat transfer from the hydraulic damper may be improved, since the vehicle body provides a heat sink. Alternatively, the second component may comprise the hydraulic damper.

The first component may form a second hydraulic cavity of the hydraulic damper. The hydraulic damper, in particular the valving assembly and/or the throttle, may be arranged in between the first hydraulic cavity and the second hydraulic cavity. The hydraulic damper may provide a dissipative fluid connection between the first hydraulic cavity and the second hydraulic cavity wherein the dissipative fluid connection may cause a damping. The hydraulic damper may be arranged in the first component, which may further comprise a mounting base, such that the vehicle body may provide a close heat sink for the dissipation heat. The hydraulic damper, in particular the throttle, may comprise a fluid channel of width in a range between 1 mm and 4 mm, preferably between 2 mm and 5 mm, preferably between 2 mm and 3 mm, preferably between 2 mm and 4 mm.

The first component may comprise the hydraulic damper. The hydraulic damper may be provided as a fluid channel in a stator rib. The stator rib may be part of the first component. The stator rib may provide a heat sink for the throttle.

The second component may comprise the hydraulic damper. The hydraulic damper may be arranged in between the first hydraulic cavity or the second hydraulic cavity, and a third hydraulic cavity. The hydraulic damper may form a fluid channel in a rotor vane. The second component may comprise the hydraulic damper, and may provide heat flow via a hydraulic fluid to the first component, and then potentially to a body of the vehicle.

The hydraulic damper may be a dissipative element with respect to a fluid flow through the hydraulic damper. The dissipative element may contribute a friction loss with respect to a fluid flow through the hydraulic damper. The hydraulic damper may comprise a fluid channel in the form of a constriction. A geometry of the hydraulic damper in combination with a fluid and a fluid flow through the hydraulic damper may be characterized by a Reynolds number in a range between 3800 to 5000, preferably in a range between 3900 to 4900, preferably in a range between 4100 to 4700, preferably in a range between 4200 to 4600, preferably in a range between 4300 to 4500, preferably in a range between 4000 and 6000, preferably in a range between 5000 and 8000, preferably higher than 2700, preferably higher than 4000. The fluid may have a kinematic viscosity in a range of 10 mm\hat{ }2/s to 100 mm\hat{ }2/s, in particular in a range of 10 mm\hat{ }2/s to 90 mm\hat{ }2/s, in particular in a range of 10 mm\hat{ }2/s to 80 mm\hat{ }2/s, in particular in a range of 10 mm\hat{ }2/s to 70 mm\hat{ }2/s, in particular in a range of 10 mm\hat{ }2/s to 60 mm\hat{ }2/s, in particular in a range of 10 mm\hat{ }2/s to 50 mm\hat{ }2/s, in particular in a range of 30 mm\hat{ }2/s to 60 mm\hat{ }2/s, in particular in a range of 40 mm\hat{ }2/s to 50 mm\hat{ }2/s. The fluid may be oil with a kinematic viscosity in a range between 20 mm\hat{ }2/s to 40 mm\hat{ }2/s, wherein the kinematic viscosity is measured in a temperature range between 10° C. and 30° C., preferably at 20° C.

The fluid may be oil with a kinematic viscosity in a range between 10 mm\hat{ }2/s to 30 mm\hat{ }2/s, wherein the kinematic viscosity is measured in a temperature range between 30° C. and 50° C., preferably at 40° C.

The aforementioned values of the kinematic viscosity may be measured in a temperature range between 20° C. and 60° C., in particular between 30° C. and 50° C., preferably at 40° C.

The second component may form a hydraulic cavity of the pneumatic spring. The hydraulic cavity may be adjacent to the pneumatic cavity. A first piston may be in the form of a floating piston. The first piston may form a boundary of the hydraulic cavity of the pneumatic spring and of the pneumatic cavity of the pneumatic spring. The first piston may be in the form of a floating piston and may reduce a mechanical connection to the pneumatic spring.

The second component may form a vane. The vane may form one side of the first hydraulic cavity. Relative rotation between the first component and the second component may alter the volume of the first hydraulic cavity. Altering the volume of the first hydraulic cavity may force a hydraulic fluid into the first hydraulic cavity or may force a hydraulic fluid out of the first hydraulic cavity.

A second piston may be provided. The second piston may be arranged rotationally fixed with respect to the first component. The hydraulic cavity of the pneumatic spring may be adapted to receive the second piston. The second piston may be arranged rotationally fixed with respect to the first component and may reduce abrasion of the second piston. The second piston may have a toroidal shape. The second piston may be a toroidal piston.

The second piston may be adapted to displace a non-compressible fluid. The non-compressible fluid may be confined in the hydraulic cavity of the pneumatic spring.

The second component may comprise a guide element, in particular a shaft. The guide element may be adapted to guide the second piston at a radial outer side with respect to the first rotation axis.

The second piston may comprise a roller. The roller may be adapted to engage with a contact surface in the hydraulic cavity, to guide the second piston at a radial outer side with respect to the first rotation axis.

Furthermore, the object is solved by a pneumatic spring, in particular for a rotary shock absorber, wherein the pneumatic spring comprises a mounting base and a pivot arm, wherein the pivot arm is rotatably arranged in the mounting base around a rotation axis, wherein a first piston forms a boundary of a pneumatic cavity in the pivot arm. The pneumatic spring is characterized in that the first piston is a floating piston. The pivot arm may comprise a protruding connection part. The protruding connection part may be radially more distant from the rotation axis than any part of the mounting base.

The protruding connection part may be adapted to receive a road wheel and/or and idler wheel of a tracked vehicle, in particular of a tank vehicle. The protruding connection part may be radially more distant from the rotation axis than any part of the mounting base and may be adapted to receive a road wheel in a radial distance from the mounting base.

The protruding connection part may be radially more distant from the rotation axis than any part of the mounting base and may be adapted to receive a road wheel in a radial distance from the mounting base, spatially separating a mounting of the road wheel from a damper function of the rotary shock absorber.

The pneumatic spring may be adapted for connection of a heavy load, wherein the heavy load may comprise a weight of at least 1000 kg, preferably the heavy weight may comprise a weight of at least 2000 kg, preferably the heavy weight may comprise a weight in the range of 2000 kg to 5000 kg, preferably the weight may comprise a weight in the range of 4000 kg to 7000 kg, preferably the weight may comprise a weight in the range of 2000 kg to 6000 kg.

The pivot arm may comprise a hydraulic cavity. The floating piston may be arranged in between the hydraulic cavity and the pneumatic cavity. In particular, the floating piston is free of a piston rod. The floating piston may be in the form of a plate.

The pneumatic cavity may comprise a first portion and a second portion. The first portion and the second portion may be in fluid connection with each other by means of a first fluid connection. The first portion may be arranged in parallel to the second portion. The first portion may be arranged at an angle with respect to the second portion. Thus, a pneumatic volume of the pneumatic cavity may be increased, while keeping a design of the pneumatic cavity compact. The piston area may be reduced and the piston displacement increased. A reduced piston size may be beneficial to maintain the positon orientation at lower piston thicknesses.

The pneumatic cavity may be adapted to form a linear displacement path for the floating piston. The displacement path may be provided in the first portion of the pneumatic cavity.

The hydraulic cavity may comprise a toroidal section and a linear section connected by a second fluid connection. The toroidal section may define a displacement path for a piston movement. The piston movement is along the displacement path. The toroidal section may enable an increase of angular displacement of the second component with respect to the first component. An increase in angular displacement may provide an increase in suspension travel of the rotary shock absorber, in particular of the pneumatic spring of the rotary shock absorber. The hydraulic cavity may contain a non-compressible fluid to displace the floating piston.

An interior of the pneumatic spring may be adapted to withstand a pressure up to 1100 bar, preferably, up to 1500 bar, preferably a pressure in a range of 140 bar to 1000 bar. The hydraulic cavity of the pneumatic spring may be adapted to withstand a pressure up to 1100 bar, preferably, up to 1500 bar, preferably a pressure in a range of 140 bar to 1000 bar. The pneumatic cavity of the pneumatic spring may be adapted to withstand a pressure up to 1100 bar, preferably, up to 1500 bar, preferably a pressure in a range of 140 bar to 1000 bar.

The second component may comprise an entrance to a cylinder, wherein the cylinder may be adapted to receive a toroidal piston, wherein the toroidal piston may be arranged positionally fixed with respect to the first component. The hydraulic cavity of the pneumatic spring may comprise the cylinder. The toroidal piston may be guided along a path, wherein the path may follow a curvature of the cylinder. The curvature of the cylinder may increase a displacement path for the toroidal piston with respect to the second component. In particular, the displacement path may be simply increased by increasing the curvature radius. Thus, the suspension travel of the pneumatic spring may be increased.

The toroidal section may comprise positionally fixed joints. A first reaction surface may be formed between the toroidal piston and a mounting base and a second reaction surface may be formed at an interface of the toroidal piston and a hydraulic fluid of the hydraulic cavity of the pneumatic spring, wherein the first reaction surface and the second reaction surface may be free of moveable joints. The toroidal section with positionally fixed joints may increase a maximum reacted load. The toroidal section with positionally fixed joints may enable higher spring forces, because the positionally fixed joints may not be displaced by a spring force and thus maintain a sealing.

A fluid conduct may be configured between the mounting base and the pivot arm of the pneumatic spring to access the hydraulic cavity of the pneumatic spring. The fluid duct may be configured as a bore. Through the fluid duct, hydraulic fluid may be introduced or extracted from the hydraulic cavity of the pneumatic spring. Thus, a temperature independent ride height adjustment of a tracked vehicle may be realized. Alternatively, an active ride height adjustment may be realized.

A bearing assembly may be arranged in the second component, wherein the bearing assembly may be adapted as a guide element for the toroidal piston. The bearing assembly may be adapted to guide the toroidal piston along the displacement path. A radial force may be exerted on the toroidal piston, wherein the radial force R may point radially away from a first rotation axis of the second component. The bearing assembly may comprise at least two bearings and a shaft, wherein the shaft may be surrounded by the at least two bearings. A guide element may be in the form of the shaft. The shaft may extend laterally through the second component. In a central section of the shaft, a recess may be provided to receive the toroidal piston. The recess may have a matching curvature with respect to a peripheral surface curvature of the toroidal piston, thus the recess may receive and center the toroidal piston.

A longitudinal symmetry axis of the shaft may be displaced by a distance from a center of a cross-section of the toroidal piston in order to reduce the radial force exerted on the toroidal piston, wherein the distance may be in a range from 50 mm to 80 mm, preferably from 50 mm to 65 mm, preferably from 65 mm to 80 mm.

A center-line radius between the first rotation axis and the center of the cross-section of the toroidal piston may be in a range between 180 mm and 220 mm, preferably between 190 mm and 210 mm, preferably between 150 mm and 210 mm.

A diameter of the toroidal piston may be in a range between 85 mm and 125 mm, preferably in a range between 95 mm and 115 mm, preferably in a range between 100 mm and 110 mm, preferably between 80 mm and 130 mm.

The second component may comprise an entrance to the cylinder, wherein a first seal and a second seal may be placed between the entrance to the cylinder and the bearing assembly. The second component may comprise a guide element, in particular a shaft. The guide element may be adapted to guide the second piston at a radial outer side with respect to a first rotation axis. The second component may be rotatably arranged relative to the first component around the first rotation axis. The guide element may be rotatably mounted around an axis perpendicular to a tangential direction of the second piston. The guide element may comprise a recess. The recess may be adapted to correspond to a part of the cross section of the second piston. The guide element may be adapted to reduce a radial elastic deformation of the second piston, in particular of a toroidal piston. The guide element may be adapted to maintain a stable centric guiding of the second piston. A sealing may be located between the second piston and the hydraulic cavity of the pneumatic spring. The guide element may be adapted to maintain a stable centric guiding of the second piston within the hydraulic cavity of the pneumatic spring, thus a force on the sealing between the second piston and the hydraulic cavity may be minimized. In particular, a stable extrusion gap between the second piston and the hydraulic cavity of the pneumatic spring may be maintained. This may also reduce a leak rate, in particular remove a leak rate, of hydraulic fluid from the hydraulic cavity to the outside of the hydraulic cavity, because a force on the sealing may be reduced.

The hydraulic damper may spatially overlap the pneumatic spring with respect to the first rotation axis. In particular, a projection of the hydraulic damper onto the first rotation axis overlaps a projection of the pneumatic spring onto the first rotation axis. The hydraulic damper may overlap the pneumatic spring by at least 20 percent, in particular by at least 30 percent, in particular by at least 40 percent, in particular by at least 50 percent, in particular by at least 60 percent, in particular by at least 70 percent, in particular by at least 80 percent, in particular by at least 90 percent, of the extension of the hydraulic damper in the direction of the first rotation axis. The overlap of the hydraulic damper with the pneumatic spring may lead to an improved heat dissipation. Heat generated by the rotary damper, in particular in the hydraulic cavity, may be dissipate through a vehicle's hull. The overlap may also lead to a space efficient design.

The hydraulic damper may spatially overlap the pneumatic spring by at least 10 millimeters, in particular by at least 30 millimeters, in particular by at least 50 millimeters, in particular by at least 70 millimeters, with respect to a direction parallel to the first rotation axis. The hydraulic damper may spatially overlap the pneumatic spring up to 100 millimeters, in particular up to 150 millimeters, in particular up to 200 millimeters, in particular up to 350 millimeters with respect to a direction parallel to the first rotation axis. In a particular embodiment, the hydraulic damper may spatially overlap the pneumatic spring by a value between 30 millimeters to 250 millimeters, in particular between 50 millimeters to 250 millimeters, in particular between 80 and 150 millimeters, with respect to a direction parallel to the first rotation axis.

The hydraulic cavity of the hydraulic damper may have width of 10 millimeters to 150 millimeters, in particular 30 millimeters to 100 millimeters, in particular 50 millimeters to 80 millimeters. In particular, the hydraulic cavity of the hydraulic damper may have an extension in a direction parallel to the first rotation axis of 10 millimeters to 300 millimeters, in particular 30 millimeters to 200 millimeters, in particular 50 millimeters to 100 millimeters.

The first component may spatially overlap the second component with respect to the first rotation axis. This may mean that a projection of the first component onto the first rotation axis overlaps a projection of the second component onto the first rotation axis. The first component may overlap the second component by at least 20 percent, in particular by at least 30 percent, in particular by at least 40 percent, in particular by at least 50 percent, in particular by at least 60 percent, in particular by at least 70 percent, in particular by at least 80 percent, in particular by at least 90 percent, of the extension of the first component in the direction of the first rotation axis.

The overlap of the first component with the second component may lead to an improved heat dissipation. The overlap may also lead to a space efficient design.

The second piston, in particular the toroidal piston, may be connected to the first component by means of a mounting assembly. The mounting assembly may be fixed, in particular rotationally fixed, to the first component. In use, a pressure inside the hydraulic cavity of the pneumatic spring may push the second piston against the mounting assembly, such that the second piston may be rotationally fixed with respect to the first component.

The mounting assembly may comprise a cam and the second piston may comprise a notch. Alternatively, the mounting assembly may comprise a notch and the second piston may comprise a cam.

The notch may be formed on a distal end of the second piston, in particular on the distal end that is not facing the pneumatic cavity of the pneumatic spring. The cam may be configured to engage with the notch. The cam may be movable relative to the second piston in the direction of the first rotation axis. This may enable an easier and more efficient manufacturing process.

The notch in the second piston may have a cylindrical shape, in particular partially a cylindrical shape. The shape of the cam may be negative with respect to the notch, such that the cam may engage with the notch. The cam may be a rounded protrusion. The shape of the cam may be different from the shape of a bolt.

Alternatively, the second piston may be connected to the mounting assembly through a bolt.

The mounting assembly may comprise a hole, in particular parallel to the first rotation axis. The hole of the mounting assembly may be configured to accommodate a bolt. A bolt may be understood as a cylindrical bar. The second piston may comprise a hole, in particular parallel to the first rotation axis. The hole of the second piston may be configured to accommodate a bolt, in particular the bolt accommodated in the hole of the mounting assembly. A bolt may be placed through the hole of the mounting assembly and the hole of the second piston, such that the second piston may be connected to the mounting assembly. The mounting assembly may be fixed to the first component. The second piston may comprise at least one protrusion, in particular primarily extending parallel to the first rotation axis. The protrusion may be configured to fit into the hole of the mounting assembly.

The second piston may be primarily arranged in a first plane, in particular orthogonal to the first rotation axis. The pneumatic cavity may be primarily arranged in a second plane. The pneumatic cavity may extend primarily in the direction of the first rotation axis. The first plane may be substantially orthogonal to the second plane.

The pneumatic cavity of the pneumatic spring may be a first pneumatic cavity. The second component may form a second pneumatic cavity of the pneumatic spring. A third piston, in particular in the form of a floating piston, may form a boundary of the first pneumatic cavity and the second pneumatic cavity. The third piston may be arranged between the first pneumatic cavity and the second pneumatic cavity. An initial pressure in the first pneumatic cavity may be different from an initial pneumatic pressure in the second pneumatic cavity. Initial may refer to the state when a vehicle that comprises the rotary shock absorber and/or the pneumatic spring is in a parking position. Initial may refer to a state where only static forces act on the rotary shock absorber and/or the pneumatic spring, but no dynamic forces.

The first pneumatic cavity of the pneumatic spring may be functionally arranged between the hydraulic cavity of the pneumatic spring and the second pneumatic cavity of the pneumatic spring. Functionally arranged may mean that an excess pressure inside the hydraulic cavity may first affect the pneumatic pressure inside the first pneumatic cavity, in particular increase the pneumatic pressure inside the first pneumatic cavity. Then, the excess pressure in the first pneumatic cavity may affect the pneumatic pressure inside the second pneumatic cavity, in particular increase the pneumatic pressure inside the second pneumatic cavity. The initial pneumatic pressure of the first pneumatic cavity may be higher than the initial pneumatic pressure of the second pneumatic cavity. This may enable a better suspension behavior.

The hydraulic damper may be arranged concentrically with respect to the pneumatic spring. The first component may be arranged concentrically with respect to the second component. A least one bearing, in particular two bearings, may be arranged between the first component and the second component. A least one bearing, in particular two bearings, may be arranged between the hydraulic damper and the pneumatic spring. The least one bearing may prevent be made of ceramic. The at least one bearing may comprise a ceramic coating. The at least one bearing may prevent heat conduction between the hydraulic damper and the pneumatic spring. The at least one bearing may prevent heat conduction between the first component and the second component. The ceramic coating may prevent heat conduction. The at least one bearing may provide heat isolation for the pneumatic spring. The at least one bearing may provide heat isolation for the second component, in particular the pneumatic cavity or pneumatic cavities in the second component. Gas inside the pneumatic cavity or pneumatic cavities and therefore the characteristics of the pneumatic spring may be very responsive to heat differences. Thus, a proper heat isolation may lead to a more robust system.

The hydraulic damper may comprise a compensation reservoir. The compensation reservoir may provide a hydraulic fluid, in particular a non-compressible fluid, to the hydraulic damper. The compensation reservoir may adjust or maintain the pressure inside the hydraulic damper. The compensation reservoir may comprise a first compensation reservoir cavity. The compensation reservoir may comprise a second compensation reservoir cavity. The first compensation reservoir cavity may contain a compressible fluid. The second compensation reservoir cavity may contain a non-compressible fluid. The second compensation reservoir cavity may be connected to the hydraulic cavity of the hydraulic damper. A compensation reservoir piston may be moveably arranged between the first compensation reservoir cavity and the second compensation reservoir cavity. The compensation reservoir piston may be a floating piston. The compensation reservoir may be comprised in the first component. The compensation reservoir may be comprised in the second component. The compensation reservoir may extend primarily in a direction parallel to the first rotation axis. In particular, the compensation reservoir may extend primarily along the first rotation axis.

The length of the compensation reservoir, in particular the extension of the compensation reservoir in a direction parallel to the first rotation axis, may be between 10 millimeters and 350 millimeters, in particular between 50 millimeters and 250 millimeters, in particular between 80 millimeters and 150 millimeters.

An assembly may comprise a vehicle, in particular a tracked vehicle, that may comprise the rotary shock absorber according to any one of the previously described embodiments or that may comprise the pneumatic spring according to any one of the previously described embodiments. An assembly may comprise the rotary shock absorber according to any one of the previously described embodiments and the rotary shock absorber may comprise the pneumatic spring according to any one of the previously described embodiments, wherein the pneumatic spring may be thermally isolated from the hydraulic damper. A thermal isolation between the pneumatic spring and the hydraulic damper may comprise a ceramic washer or a ceramic disk, functionally arranged between the pneumatic spring and the hydraulic damper. Preferably a thermal isolation between the pneumatic spring and the hydraulic damper may comprise steel, in particular, the pneumatic spring and the hydraulic damper may comprise steel. Preferably, a high thermal resistance is provided between the hydraulic damper and the pneumatic spring. Preferably a low thermal resistance is provided between the hydraulic damper and the vehicle body. A thermal isolation, in particular a high thermal resistance, between the pneumatic spring and the hydraulic damper may provide a stable pneumatic spring.

An use of the rotary shock absorber, in particular according to any previously described embodiment of the rotary shock absorber, wherein the rotary shock absorber may comprise the pneumatic spring, in particular according to any previously described embodiment of the pneumatic spring, may comprise mounting the hydraulic damper of the rotary shock absorber to a body of a vehicle, in particular of a tracked vehicle, and may comprise mounting a protruding connection part of the pneumatic spring of the rotary shock absorber to a wheel, in particular to a road wheel or an idler wheel of a tracked vehicle, to absorb a shock-like load in the hydraulic damper and to provide a resilient restoring force by the pneumatic spring to the hydraulic damper.

The use of the rotary shock absorber may comprise providing a heat flow rate from the hydraulic damper to the body of the vehicle, wherein the heat flow rate from the hydraulic damper to the body of the vehicle may be higher than a heat flow rate from the hydraulic damper to the pneumatic spring. The heat flow rate from the hydraulic damper to the body of the vehicle may be higher than a heat flow rate from the hydraulic damper to the pneumatic spring and may provide a stable pneumatic spring through a reduction of an expansion of a gaseous component of the pneumatic spring.

A wheel station for a vehicle, in particular a tracked vehicle, may comprise may comprise a rotary shock absorber and/or a pneumatic spring. A vehicle, in particular a tracked vehicle, may comprise multiple wheel stations, in particular fourteen wheel stations, in particular seven wheel stations per side. Each wheel station may comprise a rotary shock absorber. Each wheel station may comprise a pneumatic spring. In some of the wheel stations, in particular one per side, in particular, two per side, in particular three per side, in particular four per side, the hydraulic damper of the rotary shock absorber may be empty, i.e. may not contain any fluid, in particular no oil.

The expressions “first”, “second”, “third” and “fourth” are to be understood merely as des-ignations for a particular element or component and may not necessarily indicate a particular order of said components or elements. For example, the existence of a fourth element/component does not necessarily imply the existence of a first, second or third element/component, and vice versa.

Toroidal may refer to a torus, in particular part of a torus. The toroidal section of the hydraulic cavity of the pneumatic spring may have a circular cross section, an elliptical cross section or a rectangular cross section. This means that the shape of the toroidal section is defined by a circle, ellipse or rectangle, respectively that is moved along a circular curve. The second piston, in particular the toroidal piston, may have a circular cross section, an elliptical cross section or a rectangular cross section. This means that the shape of the second piston is defined by a circle, ellipse or rectangle, respectively that is moved along a circular curve.

The invention is further explained in the following on the basis of exemplary embodiments, with reference to the following figures.

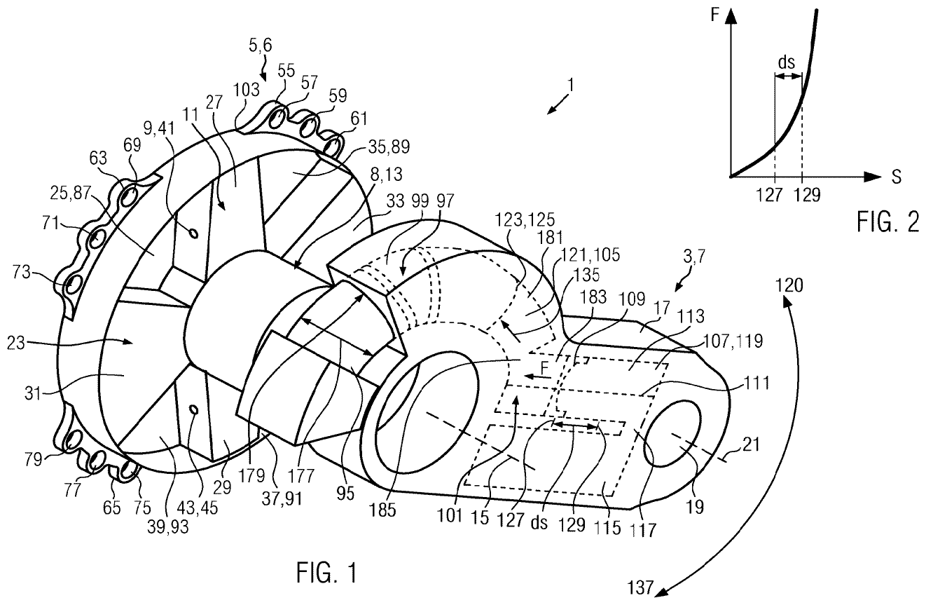

FIG. 1 is a perspective view on an embodiment of a hydropneumatic rotary suspension device, comprising a hydraulic rotary damper in a first component and a pneumatic spring in a second component.

FIG. 2 depicts a progressive dependency of a spring force F on a displacement s or ds of a spring, in particular of an embodiment of the pneumatic spring.

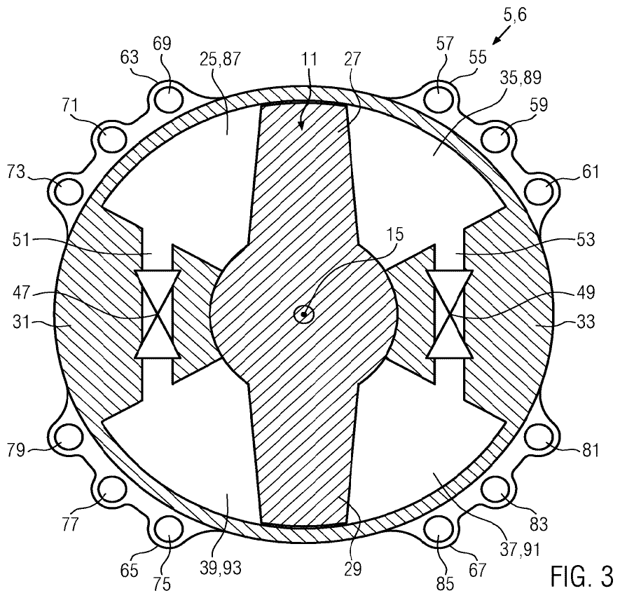

FIG. 3 is a schematic representation of a cross section through an embodiment of a hydraulic rotary damper device.

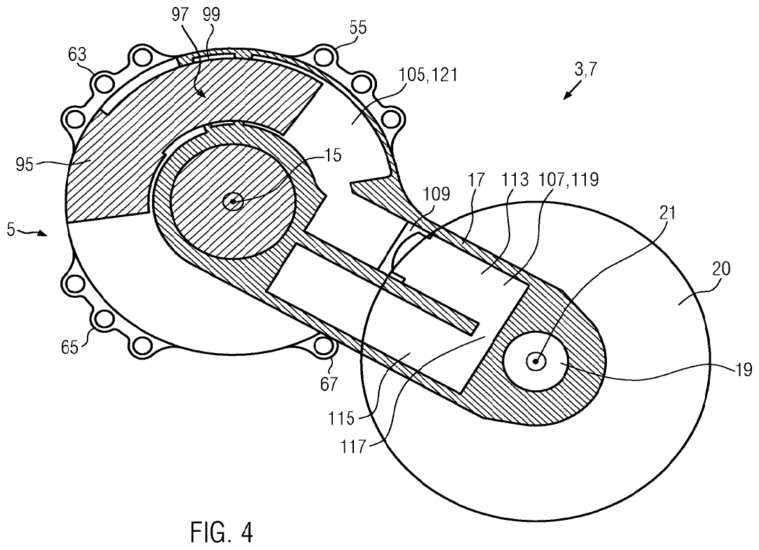

FIG. 4 is a schematic representation of a cross section through an embodiment of a pneumatic spring.

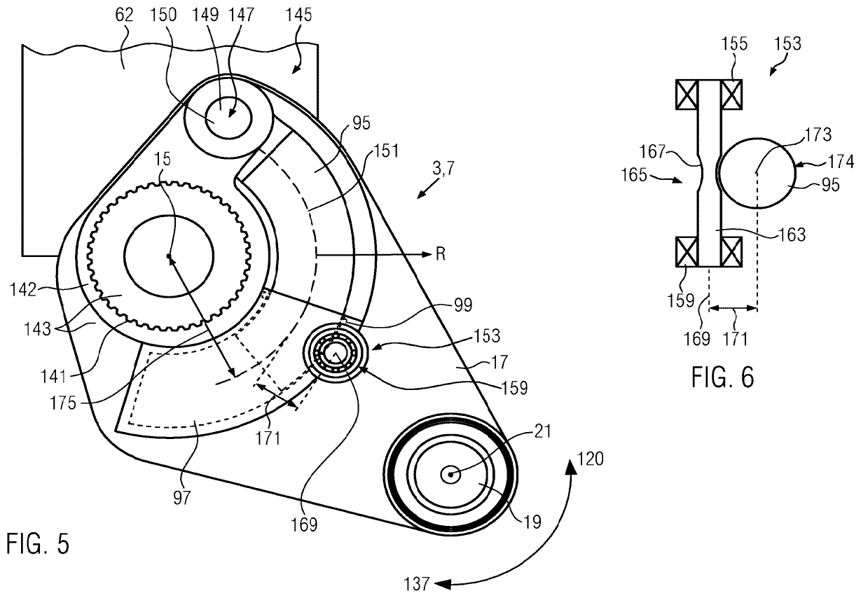

FIG. 5 is a schematic representation of a cross section through an embodiment of a second component of the hydropneumatic rotary suspension device, wherein the second component may comprise an embodiment of the pneumatic spring.

FIG. 6 is a schematic representation of a cross section through a roller bearing along a plane perpendicular to the plane of FIG. 5, wherein FIG. 6 shows a guiding of a toroidal piston.

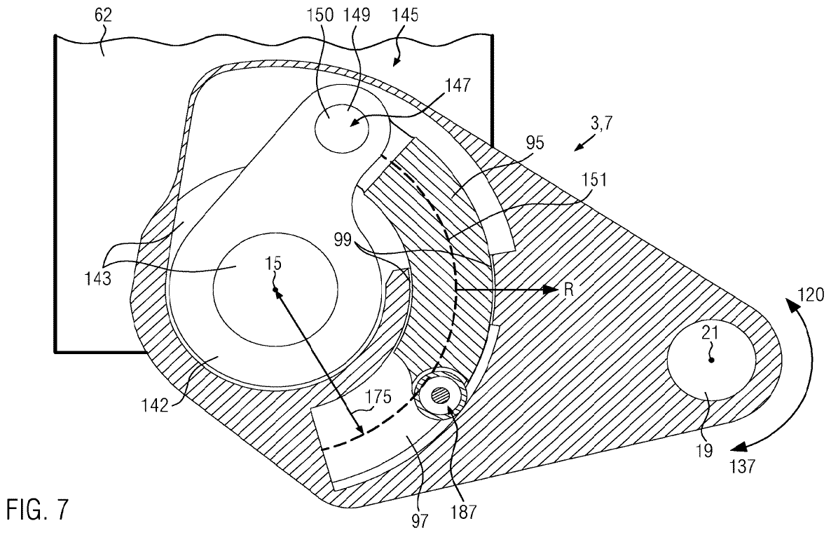

FIG. 7 is a schematic representation of a cross section through an embodiment of a second component of the hydropneumatic rotary suspension device, wherein the toroidal piston comprises a roller.

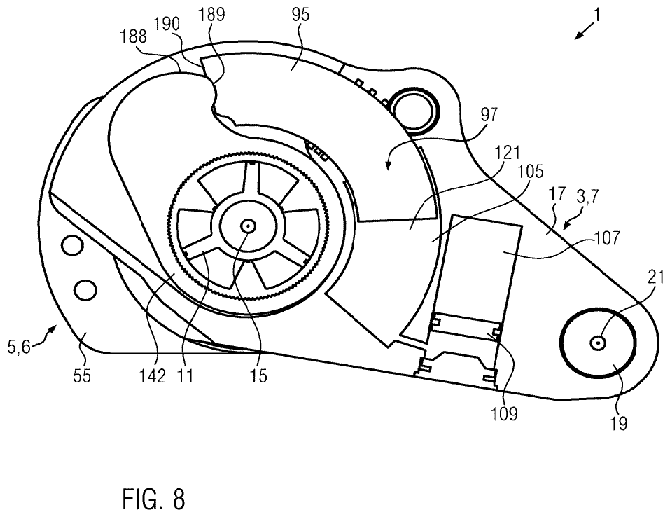

FIG. 8 is a schematic representation of a cross section through a hydropneumatic rotary suspension device, in the form of a rotary shock absorber.

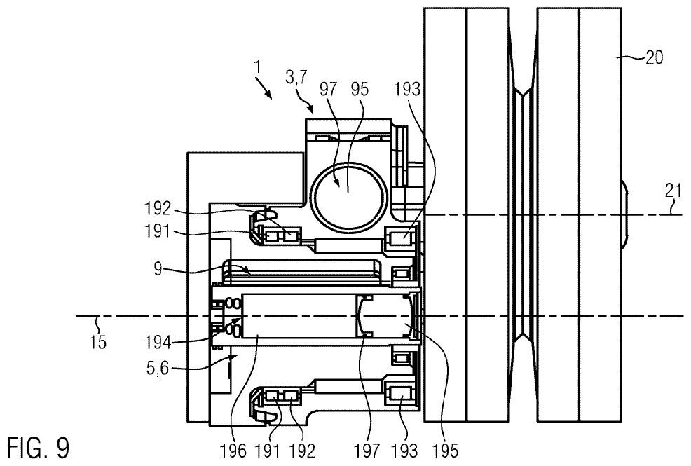

FIG. 9 is a schematic representation of a cross section through a hydropneumatic rotary suspension device and a road wheel of a tracked vehicle or an idler wheel of a tracked vehicle.

FIG. 1 shows a perspective view on an embodiment of a hydropneumatic rotary suspension device, in the form of a rotary shock absorber 1. The hydropneumatic rotary suspension device may be an assembly of a pneumatic spring 3 and a hydraulic damper device 5, in particular the hydraulic damper device 5 may be configured as a hydraulic rotary damper device 5. The hydraulic damper device 5 may be configured as a first component 6 and the pneumatic spring may be arranged in a second component 7 of the hydropneumatic rotary suspension device.

Referring to FIG. 1, the pneumatic spring 3 may be arranged in the second component 7, wherein the second component 7 may be rotatably arranged relative to the hydraulic damper device 5, wherein the hydraulic damper device 5 may be configured as the first component 6. The rotatably arranged configuration between the first component 6 and the second component 7 may be provided by a bearing assembly in a part 8 of the hydropneumatic rotary suspension device. In the interior of the hydraulic damper device 5 or the first component 6 at least one hydraulic damper 9 may be arranged.

According to an embodiment, the second component 7 may comprise the hydraulic damper 9. The hydraulic damper 9 may be arranged in a rotatable rotor vane 11, wherein the rotatable rotor vane 11 may be integral with the second component 7. The rotatable rotor vane 11 may be rotatably arranged with respect to the hydraulic damper device 5, in particular with respect to the first component 6, wherein the hydraulic damper 5, in particular the first component 6, may be positionally fixed. The rotatable rotor vane 11 may be fixedly connected to the second component 7, wherein the rotor vane 11 may be integrally formed with the second component 7, i.e. the rotatable rotor vane 11 may be non-rotatable with respect to the second component 7. The rotatable rotor vane 11 may be fixedly connected to the second component 7, wherein a connection 13 between the rotor vane 11 and the second component 7 may extend through the part 8 of the hydropneumatic rotary suspension device. Details of the connection 13 are not further shown in the embodiment of the hydropneumatic suspension device, shown in FIG. 1. A mechanical strength of the connection 13 has to be at least large enough to withstand a torque between the first component 6 and the second component 7 upon a rotation of the first component 6 relative to the second component 7 around a first rotation axis 15.

The second component 7 may comprise a pivot arm 17, wherein the pivot arm 17 may comprise a protruding connection part 19. The protruding connection part 19 may be adapted for connection of a road wheel 20 of a tracked vehicle or an idler wheel of a tracked vehicle.

The tracked vehicle may have a weight in a range of 25000 kg to 70000 kg and may comprise several road wheels 20 and may comprise several idler wheels. The hydropneumatic rotary suspension device may be designed for connection to an individual road wheel 20 or may be designed for connection to an individual idler wheel. A fraction of the weight of the tracked vehicle, carried by individual road wheels 20, may be distributed to at least one individual hydropneumatic suspension device. Several hydropneumatic suspension devices may be provided for connection to all road wheels 20 or for connection to all idler wheels. The protruding connection part 19 may comprise a second rotation axis 21 around which a rotatable road wheel 20 or a rotatable idler wheel of a tracked vehicle may be provided for rotation. The protruding connection part 19 may further comprise a bearing assembly, not further shown in FIG. 1, in order to provide a low friction rotation for the road wheel 20 or the idler wheel of the tracked vehicle.

According to an embodiment, the hydraulic damper device 5 may comprise the hydraulic damper 9. The hydraulic damper 9 may be arranged in a stator rib 23 of the hydraulic damper device 5. The stator rib 23 may be non-rotatable with respect to the hydraulic damper device 5. The stator rib 23 may be relatively rotatable with respect to the rotor vane 11 of the second component 7.

According to an embodiment, the hydraulic damper device 5 may comprise at least a first hydraulic cavity 25. The first hydraulic cavity 25 may be arranged in between the stator rib 23 and the rotor vane 11. The rotor vane 11 may comprise a first rotor vane part 27 and a second rotor vane part 29, wherein the first rotor vane part 27 is arranged opposed to the second rotor vane part 29, wherein the first rotation axis 15 may be arranged in between the first rotor vane part 27 and the second rotor vane part 29. The stator rib 23 may comprise a first stator rib part 31 and a second stator rib part 33, wherein the first stator rib part 31 may be arranged opposed to the second stator rib part 33, wherein the first rotation axis 15 may arranged in between the first stator rib part 31 and the second stator rib part 33. The hydraulic damper device 5 may comprise a second hydraulic cavity 39 and may comprise a third hydraulic cavity 37 and may comprise a fourth hydraulic cavity 35, wherein the cavities 25, 35, 37 and 39 are functionally formed with the second component 7, in particular with the rotor vane 11.

In one embodiment, the hydraulic damper 9 may be arranged in the rotor vane 11. Preferably, the hydraulic damper 9 may provide or comprise a first fluid channel 41, wherein the hydraulic damper 9 may provide a fluid connection between the first hydraulic cavity 25 and the fourth hydraulic cavity 35. The hydraulic damper 9, in particular the fluid channel 41, may be arranged in the first rotor vane part 27. The hydraulic damper 9 may be a first hydraulic damper 9, since multiple hydraulic dampers may be employed in the hydropneumatic rotary suspension device. A second hydraulic damper 43 may be arranged in the second rotor vane part 29. The second hydraulic damper 43 may provide or comprise a second fluid channel 45, wherein the second hydraulic damper 43 may provide a fluid connection between the third hydraulic cavity 37 and the second hydraulic cavity 39.

According to the embodiment shown in FIG. 3, the hydraulic damper device 5 may comprise the hydraulic damper 9. FIG. 3 shows a schematic representation of a cross section through an embodiment of a hydraulic damper device 5, in particular of the hydraulic rotary damper device 5.

The hydraulic damper 9 may be arranged in the stator rib 23 of the hydraulic damper device 5. When the hydraulic damper 9 is arranged in the stator rib 23, the rotor vane 11 may not comprise a first fluid channel 41 and a second fluid channel 45, wherein further the rotor vane 11 may not comprise the first hydraulic damper 9 and the second hydraulic damper 43.

According to an embodiment shown in FIG. 3, the hydraulic damper 9 may be arranged in the stator rib 23, and in this case the hydraulic damper 9 may be a third hydraulic damper 47, wherein the third hydraulic damper 47 may be arranged in the first stator rib part 31. A fourth hydraulic damper 49 may be arranged in the second stator rib part 33. The third hydraulic damper 47 may provide or comprise a third fluid channel 51, wherein the third hydraulic damper 47 may provide a fluid connection between the first hydraulic cavity 25 and the second hydraulic cavity 39. The fourth hydraulic damper 49 may provide or comprise a fourth fluid channel 53, wherein the fourth hydraulic damper 49 may provide a fluid connection between the fourth hydraulic cavity 35 and the third hydraulic cavity 37.

In an embodiment, the hydraulic damper device 5 may comprise a first fixture assembly 55, wherein the first fixture assembly 55 may be integral with the hydraulic damper device 5, in particular with the first component 6. The first fixture assembly 55 may comprise openings 57, 59, 61, wherein each opening 57, 59, 61 is adapted to receive a screw or a pin or a bolt or a journal in order to mount the hydraulic damper device 5 to a body 62 of the vehicle, in particular to the body 62 of the tracked vehicle (cf. FIG. 5 wherein the hydraulic damper device 5 is not shown in FIG. 5).

Preferably, the first fixture assembly 55 together with the openings 57, 59, 61 may be adapted to fix the hydraulic damper device 5 to the body 62 of the vehicle, in particular to the body 62 of the tracked vehicle, such that the hydraulic damper device 5, in particular the first component 6, may be non-rotatable with respect to the body 62 of the vehicle, in particular to the body 62 of the tracked vehicle.

Preferably, a second fixture assembly 63, a third fixture assembly 65 and a fourth fixture assembly 67 may be integral with the hydraulic damper device 5, in particular with the first component 6.

The second fixture assembly 63 may comprise openings 69, 71, 73, the third fixture assembly 65 may comprise openings 75, 77, 79 and the fourth fixture assembly 67 may comprise openings 81, 83, 85.

Preferably, the second fixture assembly 63, the third fixture assembly 65 and the fourth fixture assembly 67 together with the openings 69, 71, 73, 75, 77, 79, 81, 83 and 85 may be adapted to fix the hydraulic damper device 5, in particular the first component 6, to the body 62 of the vehicle, in particular to the body 62 of the tracked vehicle, such that the hydraulic damper device 5, in particular the first component 6, may be non-rotatable with respect to the body 62 of the vehicle, in particular to the body 62 of the tracked vehicle.

In one embodiment, a first hydraulic fluid 87 may be contained in the first hydraulic cavity 25. A fourth hydraulic fluid 89 may be contained in the fourth hydraulic cavity 35. A third hydraulic fluid 91 may be contained in the third hydraulic cavity 37. A second hydraulic fluid 93 may be contained in the second hydraulic cavity 39. The first hydraulic cavity 25, the fourth hydraulic cavity 35, the third hydraulic cavity 37 and the second hydraulic cavity 39 may be adapted to maintain a constant hydraulic pressure between the hydraulic cavities 25, 35, 37 and 39, which may be achieved by means of a central chamber and a compensation chamber as described in the document EP 3 333 447 B1.

A second piston 95, in particular a toroidal piston, may be fixedly connected to the body of the vehicle, in particular to the body of the tracked vehicle or to the hydraulic damper device 5, in order to be non-moveable with respect to the body of the vehicle, in particular with respect to the body of the tracked vehicle, or to be non-moveable with respect to the hydraulic damper device 5, in particular non-moveable with respect to the first component 6. The toroidal piston may be introduced into a first opening 97 of the second component 7, wherein the first opening may be arranged as a cylinder 97 for the toroidal piston. In the cylinder 97 of the second component 7, a first seal 99 may be arranged, in order to seal an interior 101 of the second component 7 against an outside of the second component 7. The hydraulic damper device 5 may function as a mounting base 103 for the second component 7.

The interior 101 of the second component 7 may contain the pneumatic spring 3, wherein the pneumatic spring may comprise a hydraulic cavity 105. Further, the pneumatic spring 3 may comprise a pneumatic cavity 107. The hydraulic cavity 105 of the pneumatic spring 3 and the pneumatic cavity 107 of the pneumatic spring 3 may be separated by a floating piston 109 in between the hydraulic cavity 105 of the pneumatic spring 3 and the pneumatic cavity 107 of the pneumatic spring 3. The floating piston 109 may be moveably arranged on a linear displacement path 111. The linear displacement path 111 may be functionally arranged within the pneumatic cavity 107 of the pneumatic spring 3. The pneumatic cavity 107 of the pneumatic spring 3 may comprise a first portion 113 and a second portion 115, wherein the first portion 113 may be arranged parallel to the second portion 115. The first portion 113 and the second portion 115 may be in fluid connection with each other by means of a first fluid connection 117.

The pneumatic cavity 107 of the pneumatic spring 3 may comprise a compressible fluid 119. The hydraulic cavity 105 of the pneumatic spring 3 may comprise a non-compressible fluid 121. The non-compressible fluid 121 may be adapted to displace the floating piston 109 against an elastic restoring force F, which may be provided by the compressible fluid 119.

In particular, when the second component 7 is rotated against the hydraulic damper device 5, in particular against the first component 6, around the first rotation axis 15 in a first direction 120, e.g. while absorbing a shock from the road wheel 20, the toroidal piston may push against a boundary 123 formed between the non-compressible fluid 121 and a surface 125 of the toroidal piston. The first direction 120 may be radially arranged with respect to the first rotation axis 15. The toroidal piston may push against a boundary 123 formed between the non-compressible fluid 121 and a surface 125 of the toroidal piston, which may displace the non-compressible fluid 121 and in turn may have the resulting effect of displacing the floating piston 109 along the linear displacement path 111 against the elastic restoring force F provided by the compressible fluid 119 in the pneumatic cavity 113 of the pneumatic spring 3.

In an embodiment, the pneumatic spring 3 may be adapted to provide an elastic restoring force F, in particular a progressive elastic restoring force F, with respect to a rotation around the first rotation axis 15 in the first direction 120.

In particular, the progressive elastic restoring force F may prevent that a road wheel 20, attached to the protruding connection part 19, may hit the body 62 of the vehicle, in particular the body 62 of the tracked vehicle.

In particular, the floating piston 109 may be displaced from a first position 127 to a second position 129 over a distance ds, and in this case the restoring force F may be provided by the compressible fluid 119 in the pneumatic cavity 107 of the pneumatic spring 3. The elastic restoring force F may push the floating piston 109 from the second position 129 back to the first position 127. A dependency between the elastic restoring force F and displacement path ds may follow an exponential behavior as shown in FIG. 2. In particular, the elastic restoring force F may increase exponentially when the floating piston is pushed from the first position 127 to the second position 129. The elastic restoring force F may have a direction along the linear displacement path 111, wherein the direction of the elastic restoring force F has a sense of direction as indicated in FIG. 1, such that the floating piston 109 may be pushed back from the second position 129 to the first position 127 along the linear displacement path 111.

In particular, the floating piston 109 may be pushed back from the second position 129 to the first position 127, wherein the floating piston 109 may displace the non-compressible fluid 121 in the hydraulic cavity 105 in a second direction 135. The non-compressible fluid 121 may be displaced by the floating piston 109 in the second direction 135, wherein the floating piston 109 may have the effect to push the non-compressible fluid 121 against the surface 125 of the toroidal piston. In this case the restoring force F may not only displace the non-compressible fluid 121 in the second direction 135, but may lead to a resulting rotation of the second component 7 around the first rotation axis 15 in a third direction 137, wherein the third direction 137 may be radially arranged with respect to the first rotation axis 15.

The second component 7 may be rotated around the first rotation axis 15 in the first direction 120 and back in the third direction 137 due to the elastic restoring force F, wherein the hydraulic damper 9, 43, 49, 47 may damp the movement of the second component 7. In particular the hydraulic damper 9, 43, 49, 47 may damp an elastic swinging of the second component 7 around the first rotation axis 15, wherein the elastic swinging may occur due to the action of the pneumatic spring 3 if no damping would occur.

In one embodiment the hydraulic dampers 9, 43 may be arranged in the rotor vane 11. A rotation of the second component 7 in the first direction 120 may lead to a rotation of the rotor vane 11 in the first direction 120 as well, since second component 7 and rotor vane 11 may be formed integrally.

A rotation of the rotor vane 11 in the first direction 120 may lead to a decreasing volume of the first hydraulic cavity 25 and may lead to an increasing volume of the fourth hydraulic cavity 35. Further, a rotation of the rotor vane 11 in the first direction 120 may lead to an increasing volume of the second hydraulic cavity 39 and may lead to a decreasing volume of the third hydraulic cavity 37.

Because the volume of the first hydraulic cavity 25 may decrease when the second component 7 is rotated in the first direction 120, the first hydraulic fluid 87 may be pushed through the hydraulic damper 9, in particular through the first fluid channel 41, into the fourth hydraulic cavity 35. In the fourth hydraulic cavity 35, a mixture comprising the first hydraulic fluid 87 and the fourth hydraulic fluid 89 may build up as a result.

Because the volume of the third hydraulic cavity 37 may decrease when the second component 7 is rotated in the first direction 120, the third hydraulic fluid 91 may be pushed through the second hydraulic damper 43, in particular through the second fluid channel 45, into the second hydraulic cavity 39. In the second hydraulic cavity 39, a mixture comprising the third hydraulic fluid 91 and the second hydraulic fluid 93 may build up as a result.

The hydraulic damper 9 and the second hydraulic damper 43 may comprise a throttle or a constriction. The first hydraulic fluid 87 may flow through the first fluid channel 41 and the third hydraulic fluid 91 may flow through the second fluid channel 45, wherein dissipation may occur in the first fluid channel 41 and in the second fluid channel 45. The dissipation that may occur in the first fluid channel 41 and in the second fluid channel 45 may be due to friction loss of the first hydraulic fluid 87 at a wall of the first fluid channel 41 and may be due to friction loss of the hydraulic fluid 91 at a wall of the third fluid channel 45.

The second component 7 may rotate around the first rotation axis 15 in the third direction 137 due to the elastic restoring force F, wherein the mixture comprising the first hydraulic fluid 87 and the fourth hydraulic fluid 89 in the fourth hydraulic cavity 35 may flow through the first hydraulic channel 41 into the first hydraulic cavity 25. The mixture comprising the first hydraulic fluid 87 and the fourth hydraulic fluid 89 may flow through the first hydraulic channel 41, wherein dissipation may occur in the first fluid channel 41. The dissipation that may occur in the first fluid channel 41 may be due to friction loss of the mixture comprising the first hydraulic fluid 87 and the fourth hydraulic fluid 89 at the wall of the first fluid channel 41.

The second component 7 may rotate around the first rotation axis 15 in the third direction 137 due to the elastic restoring force F, wherein the mixture comprising the third hydraulic fluid 91 and the second hydraulic fluid 93 in the second hydraulic cavity 39 may flow through the second hydraulic channel 45 into the third hydraulic cavity 37. When the mixture comprising the third hydraulic fluid 91 and the second hydraulic fluid 93 may flow through the second hydraulic channel 45, dissipation may occur in the second fluid channel 45. The dissipation that may occur in the second fluid channel 45 may be due to friction loss of the mixture comprising the third hydraulic fluid 91 and the second hydraulic fluid 93 at the wall of the second fluid channel 45.

According to the embodiment of the hydraulic damper device 5 shown in FIG. 3, the rotor vane 11 does not comprise a hydraulic damper and/or a hydraulic channel. Instead, the third hydraulic damper 47 may be arranged in the first stator rib part 31 and the fourth hydraulic damper 49 may be arranged in the second stator rib part 33. Further, a third fluid channel 51 may be provided in the first stator rib part 31 by the third hydraulic damper 47 and a fourth fluid channel 53 may be provided in the second stator rib part 33 by the fourth hydraulic damper 49. A rotation of the second component 7 in the first direction 120 may lead to a rotation of the rotor vane 11 in the first direction 120.

A rotation of the rotor vane 11 in the first direction 120 may lead to a decreasing volume of the first hydraulic cavity 25 and may lead to an increasing volume of the fourth hydraulic cavity 35. Further, a rotation of the rotor vane 11 in the first direction 120 may lead to an increasing volume of the second hydraulic cavity 39 and may lead to a decreasing volume of the third hydraulic cavity 37.

Because the volume of the first hydraulic cavity 25 may decrease while the second component 7 is rotated in the first direction 120, the first hydraulic fluid 87 may be pushed through the third hydraulic damper 47, in particular through the third fluid channel 51 into the second hydraulic cavity 39. In the second hydraulic cavity 39, a mixture comprising the first hydraulic fluid 87 and the second hydraulic fluid 93 may build up as a result.

Because the volume of the third hydraulic cavity 37 may decrease while the pneumatic spring 3 is rotated in the first direction 120, the third hydraulic fluid 91 may be pushed through the fourth hydraulic damper 49, in particular through the fourth fluid channel 53 into the fourth hydraulic cavity 35. In the fourth hydraulic cavity 35, a mixture comprising the third hydraulic fluid 91 and the fourth hydraulic fluid 89 may build up as a result.

The third hydraulic damper 47 and the fourth hydraulic damper 49 may comprise a throttle or a constriction. The first hydraulic fluid 87 may flow through the third fluid channel 51 and the third hydraulic fluid 91 may flow through the fourth fluid channel 53, wherein dissipation may occur in the third fluid channel 51 and in the fourth fluid channel 53. The dissipation that may occur in the third fluid channel 51 and in the fourth fluid channel 53 may be due to friction loss of the first hydraulic fluid 87 at a wall of the third fluid channel 51 and may be due to friction loss of the third hydraulic fluid 91 at a wall of the fourth fluid channel 53.

The second component 7 may rotate around the first rotation axis 15 in the third direction 137 due to the elastic restoring force F, wherein the mixture comprising the first hydraulic fluid 87 and the second hydraulic fluid 93 in the second hydraulic cavity 39 may flow through the third hydraulic channel 51 into the first hydraulic cavity 25. The mixture comprising the first hydraulic fluid 87 and the second hydraulic fluid 93 may flow through the third hydraulic channel 51, wherein dissipation may occur in the third fluid channel 51. The dissipation that may occur in the first fluid channel 51 may be due to friction loss of the mixture comprising the first hydraulic fluid 87 and the second hydraulic fluid 93 at the wall of the third fluid channel 51.

The second component 7 may rotate around the first rotation axis 15 in direction 137 due to the elastic restoring force F, wherein the mixture comprising the fourth hydraulic fluid 89 and the third hydraulic fluid 91 in the fourth hydraulic cavity 35 may flow through the fourth hydraulic channel 53 into the third hydraulic cavity 37. The mixture comprising the fourth hydraulic fluid 89 and the third hydraulic fluid 91 may flow through the fourth hydraulic channel 51, wherein dissipation may occur in the fourth fluid channel 53. The dissipation that may occur in the fourth fluid channel 53 may be due to friction loss of the mixture comprising the fourth hydraulic fluid 89 and the third hydraulic fluid 91 at the wall of the fourth fluid channel 53.

Preferably, in order to provide a particularly tight sealing of the interior 101 of the second component 7 against an outside of the second component 7, additional to the first seal 99 in the cylinder 97 of the second component 7, a second seal may be provided in the cylinder 97 of the second component 7. FIG. 4 shows a schematic representation of a cross section through an embodiment of a pneumatic spring 3, wherein one end of the second component 7 is connected to a road wheel, in particular of a tracked vehicle.

FIG. 5 shows a schematic representation of a cross section through an embodiment of the second component 7 which may comprise the pneumatic spring 3. FIG. 6 shows a schematic representation of a cross section of a roller bearing according to an embodiment of the second component 7. As described before, the second component 7 may be rotated around the first rotation axis 15 in the first direction 120 or in the third direction 137 with respect to the positionally fixed hydraulic rotary damper 5, in particular with respect to the positionally fixed first component 6. The second component 7 may be rotated around the first rotation axis 15, wherein also the rotor vane 11 may be rotated around the first rotation axis 15 in a direction 120 or in a direction 137, because the second component 7 may be fixedly connected to the rotor vane 11. A connection between the toroidal piston and the body 62 of the vehicle may be provided by an indirect connection between the toroidal piston and the body 62 of the vehicle by means of a spline joint 141 between a first mounting assembly 142 and a second mounting assembly 143 of the body 62 of the vehicle. The spline joint 141 may provide a rotationally fixed connection between the first mounting assembly 142 and the second mounting assembly 143 of the body of the vehicle 62. A first part 145 of the first mounting assembly 142 may be provided opposed to a part of the toroidal piston that may extend into the cylinder 97. The first part 145 of the first mounting assembly 142 may comprise a connection assembly 147. The connection assembly 147 may comprise an opening 149. The opening 149 may be adapted to receive a bolt 150, wherein the bolt 150 may fixedly connect the first part 145 of the first mounting assembly 142 to the toroidal piston. In particular, this may provide to rotate the second part 7 around the first rotation axis 15 in the first direction 120 or in the third direction 137 while the toroidal piston may remain positionally fixed, in particular the toroidal piston may remain positionally fixed with respect to the body 62 of the vehicle.

The toroidal piston may be guided along a path 151, wherein the path 151 may follow a curvature of the cylinder 97. In an embodiment of the second component 7, a bearing assembly 153 may be provided in the second component 7, wherein the bearing assembly 153 may be arranged in the second component 7. The bearing assembly 153 may be adapted to guide the toroidal piston along the path 151, despite a radial force R which may be exerted on the toroidal piston, wherein the radial force R may point radially away from the first rotation axis 15. The bearing assembly 153 may comprise bearings 155, 159 and a guide element in the form of a shaft 163. The shaft 163 is rotatably arranged in bearings 155, 159. The shaft 163 may extend laterally through the second component 7. In a central section 165 of the shaft 163, a recess 167 may be provided to receive the toroidal piston. The recess 167 may have a matching curvature with respect to a peripheral surface curvature of the toroidal piston.

A longitudinal symmetry axis 169 of the shaft 163 may be displaced by a distance 171 from a center 173 of a cross-section 174 of the toroidal piston. The distance 171 may be in a range from 50 mm to 80 mm, preferably from 50 mm to 65 mm, preferably from 65 mm to 80 mm. A center-line radius 175 between the first rotation axis 15 and the center 173 of the cross-section 174 of the toroidal piston may be in a range between 180 mm and 220 mm, preferably between 190 mm and 210 mm.

Preferably, a diameter 177 of the toroidal piston, as shown in FIG. 1, may be in a range between 85 mm and 125 mm, preferably in a range between 95 mm and 115 mm, preferably in a range between 100 mm and 110 mm.

The second component 7 may comprise an entrance 179 to the cylinder 97, wherein the first seal 99 may be placed between the entrance 179 to the cylinder 97 and the bearing assembly 153.

The floating piston 109 may be a first piston of the hydropneumatic suspension device and the toroidal piston may be a second piston 95 of the hydropneumatic suspension device.

The hydraulic cavity 105 of the pneumatic spring 3 may comprise a toroidal section 181 and a linear section 183, connected by a second fluid connection 185.

In particular, the interior 101 of the pneumatic spring 3 may be adapted to withstand pressures up to 1100 bar, preferably, up to 1500 bar.

In particular, the hydraulic cavity 105 of the pneumatic spring 3 may be adapted to withstand pressures up to 1100 bar, preferably, up to 1500 bar.

FIG. 7 shows a schematic representation of a cross section through an embodiment of a second component 7 of the hydropneumatic rotary suspension device. A toroidal piston with a roller 187 arranged at an end of the toroidal piston proximate to where the second reaction surface may be formed is shown. The roller 187 may be adapted to engage with a contact surface in the hydraulic cavity 105. By this the toroidal piston is guided along the path 151, wherein the path 151 may follow a curvature of the cylinder 97. The roller 187 is at least temporarily in contact with the contact surface. Through the roller 187 that may engage with the contact surface, the toroidal piston may be guided at a radial outer side with respect to the first rotation axis.

FIG. 8 shows a schematic representation of a cross section through a hydropneumatic rotary suspension device, in the form of a rotary shock absorber 1. The second piston 95 is a toroidal piston and arranged inside the cylinder 97 of the second component 7. On a distal end 190 of the second piston 95, in particular the distal end 190 that is not facing the pneumatic cavity 107 of the pneumatic spring 3, the second piston 95 comprises a notch 189. The first component 6 comprises a mounting assembly 142. The mounting assembly comprises a cam 188. The second piston 95 is connected to the first component 6 by means of the mounting assembly 142. In particular, the cam 188 of the mounting assembly 142 engages the notch 189 of the second piston 95.

FIG. 9 shows a schematic representation of a cross section through a hydropneumatic rotary suspension device and a wheel 20 of a tracked vehicle or an idler wheel of a tracked vehicle. The hydraulic damper 9 spatially overlaps the pneumatic spring 3 with respect to the first rotation axis 15. First, second and third bearings 191, 192, 193 are arranged between the first component 6 and the second component 7. The bearings 191, 192, 193 enable relative rotation between the first component 6 and the second component 7. The hydraulic damper device 5 comprises a compensation reservoir 194, primarily extending along the first rotation axis 15. The compensation reservoir 194 comprises a first compensation reservoir cavity 195, filled with a compressible fluid, and a second compensation reservoir cavity 196, filled with non-compressible hydraulic fluid. A compensation reservoir piston 197 is moveably arranged between the first compensation reservoir cavity 195 and the second compensation reservoir cavity 196.

1. A rotary shock absorber (1) for a vehicle, comprising:
a first component (6); and
a second component (7);
wherein the second component (7) is rotatably arranged relative to the first component (6) around a first rotation axis (15);
wherein a pneumatic spring (3) is adapted to provide an elastic force (F) against rotation of the second component (7) relative to the first component (6);
wherein the second component (7) forms a pneumatic cavity (107) of the pneumatic spring (3);
wherein the second component (7) forms a hydraulic cavity (105) of the pneumatic spring (3);
wherein the hydraulic cavity (105) comprises a toroidal section (181));
wherein the hydraulic cavity (105) is adjacent to the pneumatic cavity (107);
wherein a first piston (109) in the form of a floating piston forms a boundary of the hydraulic cavity (105) of the pneumatic spring (3) and of the pneumatic cavity (107) of the pneumatic spring (3).

2. The rotary shock absorber according to claim 1, wherein the hydraulic cavity (105) comprises a linear section (183) connected to the toroidal section (181) by a fluid connection (185).

3. The rotary shock absorber according to claim 1, wherein a hydraulic damper (9, 43, 47, 49) is functionally arranged in parallel to the pneumatic spring (3);
wherein the hydraulic damper (9, 43, 47, 49) is adapted to provide a damping force against a rotation of the second component (7) relative to the first component (6); and
wherein the hydraulic damper (9, 43, 47, 49) comprises a first hydraulic cavity (25) formed between the first component (6) and second component (7).

4. The rotary shock absorber according to claim 3, wherein the first component (6) comprises the hydraulic damper (47, 49).

5. The rotary shock absorber according to claim 3, wherein the second component (7) forms a vane (11), wherein the vane (11) forms one side of the first hydraulic cavity (25), wherein relative rotation between the first component (6) and the second component (7) alters the volume of the first hydraulic cavity (25).

6. The rotary shock absorber according to claim 3, wherein the first component (6) forms a second hydraulic cavity (39) of the hydraulic damper (47) and the hydraulic damper (47) is in the form of a valving assembly in between the first hydraulic cavity (25) and the second hydraulic cavity (39).

7. The rotary shock absorber according to claim 3, wherein the hydraulic damper (9, 43, 47, 49) spatially overlaps the pneumatic spring (3) with respect to the first rotation axis (15) by at least 30 percent of the hydraulic damper's (9, 43, 47, 49) extension in a direction of the first rotation axis (15).

8. The rotary shock absorber according to claim 1, wherein a second piston (95) is arranged rotationally fixed with respect to the first component (6), wherein the hydraulic cavity (105) of the pneumatic spring (3) is configured to receive the second piston (95).

9.-11. (canceled)

12. The rotary shock absorber according to claim 8, wherein the second piston (95) is connected to the first component (6) by a mounting assembly (142);
wherein the mounting assembly (142) comprises one of a cam (188) and a notch (189);
wherein the second piston (95) comprises the other of the cam (188) and the notch (189) formed on a distal end (190) of the second piston (95); and
wherein the cam (188) is configured to engage the notch (189).

13. The rotary shock absorber according to claim 1, wherein the pneumatic cavity (107) of the pneumatic spring (3) is a first pneumatic cavity, wherein the second component (7) forms a second pneumatic cavity of the pneumatic spring (3);
wherein a third piston forms a boundary of the first pneumatic cavity and the second pneumatic cavity; and
wherein an initial pneumatic pressure in the first pneumatic cavity of the pneumatic spring (3) is different from an initial pneumatic pressure in the second pneumatic cavity of the pneumatic spring (3).

14. (canceled)

15. The rotary shock absorber according to claim 1, wherein at least one bearing is arranged between the first component (6) and the second component (7); and
wherein the at least one bearing is made of ceramic or comprises a ceramic coating.

16. A pneumatic spring (3) for a rotary shock absorber (1) according to claim 1, the pneumatic spring (3) comprising:
a mounting base (5, 103); and
a pivot arm (17);
wherein the pivot arm (17) is rotatably arranged in the mounting base (5, 103) around a rotation axis (15);
wherein a first piston (109) forms a boundary of a pneumatic cavity (107) in the pivot arm (17);
wherein the pivot arm (17) comprises a hydraulic cavity (105); and
wherein the hydraulic cavity (105) comprises a toroidal section (181), wherein the first piston (109) is a floating piston.

17. The pneumatic spring according to claim 16, wherein
the pivot arm (17) comprises a protruding connection part (19), wherein the protruding connection part (19) is radially more distant from the rotation axis (15) than any part of the mounting base (5, 103).

18. The pneumatic spring according to claim 16, wherein the first piston (109) is arranged in between the hydraulic cavity (105) and the pneumatic cavity (107).

19. The pneumatic spring according to claim 18, wherein
the pneumatic cavity (107) comprises a first portion (113) and a second portion (115), wherein the first portion (113) and the second portion (115) are in fluid connection with each other by a first fluid connection (117), wherein the first portion (113) is arranged in parallel to the second portion (115) or wherein the first portion (113) is arranged at an angle with respect to the second portion (115).

20. The pneumatic spring according to claim 19, wherein the pneumatic cavity (107) is configured to form a linear displacement path (111) for the first piston (109), wherein the linear displacement path (111) is provided in the first portion (113) of the pneumatic cavity (107).

21. The pneumatic spring according to claim 18, wherein the hydraulic cavity (105) comprises a linear section (183) connected to the toroidal section (181) by a second fluid connection (185).

22. (canceled)

23. A tracked vehicle, in particular a tracked vehicle, comprising the rotary shock absorber (1) according to claim 1.

24. (canceled)

25. A otary shock absorber according to claim 1, wherein the pneumatic cavity (107) is configured to form a linear displacement path for the floating piston (109).

26. A tracked vehicle comprising the pneumatic spring (3) according to claim 16.
